(19) United States
(12) Patent Application Publication
(10) Pub. No.: US 2009/0164849 A1
(43) Pub. Date: Jun. 25, 2009

(54) TERMINAL APPARATUS, FAULT DIAGNOSIS METHOD AND PROGRAM THEREOF

(75) Inventor: Shunji SUGAYA, Tokyo (JP)

Correspondence Address: CARTER, DELUCA, FARRELL & SCHMIDT, LLP, 445 BROAD HOLLOW ROAD, SUITE 420, MELVILLE, NY, 11747, US

(73) Assignee: OPTiM CORPORATION, Saga (JP)

(21) Appl. No.: 12/341,599

(22) Filed: Dec. 22, 2008

(30) Foreign Application Priority Data
Dec. 25, 2007 (JP) 2007-332153

(51) Int. Cl. G06F 11/36

(52) U.S. Cl. 714/38; 714/E11.219

(57) ABSTRACT

A terminal apparatus diagnoses a status of operation of software with the execution of a plurality of diagnostic programs so as to diagnose contents established for the software related to a plurality of functional blocks of the terminal apparatus. The terminal apparatus includes a storage device, a controller, and a display device. The storage device stores the plurality of diagnostic programs that are each provided in advance with a class identification in order of descending priority thereof. The controller is configured to: update a class identification in the order of priority; read out a diagnostic program associated with the class identification from the storage device at each time of updating; and cause the diagnostic program to be executed. The display device displays a code indicating a result of a diagnosis as a result of the execution of the diagnostic program.

This application is based on and claims the benefit of priority from Japanese Patent Application No. 2007-332153, filed on 25 Dec. 2007, the content of which is incorporated herein by reference.

### BACKGROUND OF THE INVENTION

1. Field of the Invention

The present invention relates to a terminal apparatus, and a method and program for fault diagnosis that can detect a fault of a diagnostic item earlier the higher its priority is.

2. Related Art

Conventionally, as in Japanese Unexamined Patent Application Publication No. 2006-201927, technology related to a device fault diagnosis apparatus has a table associating fault portions in which a fault may occur with error codes related to the fault portions, in which a fault portion can be specified easily based on an error code included in a monitoring information obtained through a printer by referring to the table, whereby there is no need, for example, for a serviceman to go out to the printer's location in order to examine the printer.

In the case of the abovementioned technology where the monitoring information including an error code is transmitted to a server when a fault occurs in the apparatus is made available for a personal computer, since diagnostic items such as those of a personal computer require at least several minutes to complete a diagnosis for every item, the error code would need to be transmitted in series during the diagnosis.

However, there are various types of faults, such as severe faults and relatively minor faults, which may occur in a personal computer, and it is possible that an error code for the severe fault may be transmitted at almost the end of the diagnosis.

Thus, the earlier detection of a fault of a diagnostic item with the higher priority has been desired.

### SUMMARY OF THE INVENTION

The present invention, in view of the foregoing, has an object of providing a terminal apparatus, and a method and program for fault diagnosis that can detect a fault of a diagnostic item earlier the higher its priority is.

In an aspect of the present invention, a terminal apparatus is provided, which diagnoses the operation status of software with the execution of a plurality of diagnostic programs so as to diagnose contents established for the software related to a plurality of functional blocks of the terminal apparatus. The terminal apparatus includes a first storage device, a controller, and a display device. The first storage device stores the plurality of diagnostic programs that are each provided in advance with a first class identification in first order of descending priority thereof. The controller is configured to: update a first class identification in the first order of priority; read out a diagnostic program associated with the first class identification from the first storage device at each time of updating; and cause the diagnostic program to be executed. The display device displays a code indicating a result of a diagnosis as a result of the execution of the diagnostic program.

In another aspect of the present invention, a terminal apparatus is provided, which further includes a second storage device and an input device. The second storage device stores a second class identification that can be assigned priority in second order different from the first order, in addition to the first class identification. The controller is further configured to: read out a second class identification from the second storage device and cause the display device to display the second class identification along with a diagnostic item performed by a diagnostic program; allow a user to instruct through the input device a change of the second class identification displayed by the display device; update the second class identification stored in the second storage device in accordance with the instruction provided by the user through the input device; and read out a diagnostic program corresponding to the second class identification from the first storage device in accordance with the second class identification read out from the second storage device and cause the diagnostic program to be executed.

In still another aspect of the present invention, a terminal apparatus is provided, in which the display device displays a diagnostic code in a case where a diagnostic result has been obtained that indicates the environmental information including a condition established for the software, whether the contents established for the software are valid, and a type of an operating system, and the environmental condition including a result of operation.

In yet another aspect of the present invention, a terminal apparatus is provided, which further includes a transmitter for transmitting a diagnostic code indicating a diagnostic result as a result of the execution of the diagnostic program to a central apparatus, and a receiver for receiving text data related to a solution corresponding to the diagnostic code from the central apparatus.

In a further aspect of the present invention, a terminal apparatus is provided, in which the transmitter transmits a diagnostic code in a case where a diagnostic result has been obtained that indicates the environmental information including a condition established for the software, whether the contents established for the software are valid, and a type of an operating system, and the environmental condition including a result of operation.

In a still further aspect of the present invention, a terminal apparatus is provided, in which the diagnostic code includes a 2-byte code.

In a yet further aspect of the present invention, a terminal apparatus is provided, in which the controller is further configured to: cause the display device to display diagnostic items to be used for diagnosing the contents established for the software; allow the user to enter an instruction for selecting a diagnostic item through the input device; read out a diagnostic program from the first storage device in accordance with the diagnostic item entered by the user; and cause the diagnostic program to be executed.

In another aspect of the present invention, a terminal apparatus is provided, further including a third storage device. The third storage device stores historical data related to time at which a diagnostic program is executed, along with a diagnostic code and a first class identification corresponding thereto. When the time read from the third storage device lies within a predetermined period of time, the controller is configured to inhibit the execution of the diagnostic program at a start of the terminal apparatus.

In still another aspect of the present invention, a terminal apparatus is provided, further including a third storage device for storing historical data related to time at which a diagnostic program is executed, along with a diagnostic code and a class identification corresponding thereto. After a start of an operating system of the terminal apparatus or when a load imposed on the controller is continuously low, the controller is further configured to: execute one of a part and the entirety of the diagnostic programs; and cause the historical data to be stored in the third storage device while causing the diagnostic code not to be displayed on the display device.

In yet another aspect of the present invention, a method is provide, which is for diagnosing the operation status of software with a plurality of diagnostic programs that diagnoses contents established for the software related to a plurality of functional blocks of the terminal apparatus. The method including: causing a storage device to store the plurality of diagnostic programs that are each provided in advance with a class identification in order of descending priority thereof; updating a class identification in the order of priority; reading out a diagnostic program associated with the class identification from the storage device at each time of updating; causing the diagnostic program to be executed; and displaying a code indicating a result of a diagnosis as a result of the execution of the diagnostic program.

In a further aspect of the present invention, a storage medium is provided, which is encoded with a machine-readable computer program code for diagnosing the operation status of software so as to diagnose contents established for the software related to a plurality of functional blocks. The storage medium includes instructions for causing a controller to implement a method including: causing a storage device to store the plurality of diagnostic programs that are each provided in advance with a class identification in order of descending priority thereof; updating a class identification in the order of priority; reading out a diagnostic program associated with the class identification from the storage device at each time of updating; causing the diagnostic program to be executed; and displaying a code indicating a result of a diagnosis as a result of the execution of the diagnostic program.

According to the present invention, a fault of a diagnostic item with high-ranking priority can be detected earlier.

### BRIEF DESCRIPTION OF THE DRAWINGS

FIG. 1 is a system configuration diagram which shows a schematic configuration applied to a fault diagnosis system according to a first embodiment of the present invention;

FIG. 2 is a flowchart illustrating an operation of a fault diagnosis system according to a first embodiment;

FIG. 3 shows an initial screen 51 displayed on a PC monitor on the user side;

FIG. 4 shows a message screen 55 displayed on a PC monitor on the user side;

FIG. 5 shows a configuration of a diagnostic item table 36b;

FIG. 6 is a diagnostic result table 57 including result data related to a communication functional block provided on a PC on the user side;

FIG. 7 shows a table displayed on a monitor 33 as a diagnostic result;

FIG. 8 is a flowchart illustrating the operation of a web server;

FIG. 9 is a flowchart for illustrating the operation of a PC 21-n;

FIG. 10 is a system configuration diagram showing a schematic configuration applied to a fault diagnosis system according to a second embodiment of the present invention;

FIG. 11 shows a configuration of a conversion table 36g;

FIG. 12 is a flowchart for illustrating the operation of a fault diagnosis system of the first embodiment;

FIG. 13 shows an initial screen 71 displayed on a PC monitor on the user side;

FIG. 14 shows a screen 75 for setting a diagnostic item displayed on a PC monitor on the user side;

FIG. 15 shows a screen 76 for setting a diagnostic item displayed on a PC monitor on the user side;

FIG. 16 is a flowchart for illustrating the operation of a fault diagnosis system of the second embodiment;

FIGS. 17A and 17B are flowcharts for illustrating the operation of a fault diagnosis system of a third embodiment; and

FIG. 18 shows an initial screen 91 displayed on a PC monitor on the user side.

### DETAILED DESCRIPTION OF THE INVENTION

In the following, embodiments of the present invention are described with reference to the accompanying drawings.

### First Embodiment

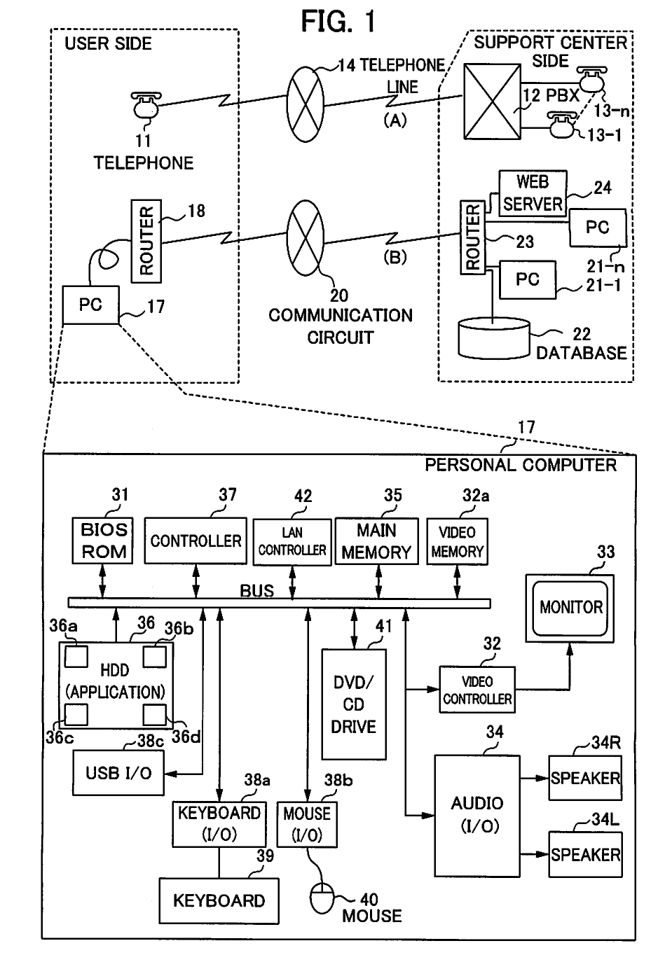

FIG. 1 is a system configuration diagram showing a schematic configuration applied to a fault diagnosis system according to a first embodiment of the present invention. Symbol (A) in FIG. 1 represents telephonic connection between a user and a support center. Symbol (B) represents communicative connection between personal computers (PCs) provided on a user side and a support center side.

As shown by symbol (A) in FIG. 1, a telephone line 14 is connected to a telephone 11 provided on the user side and telephones 13-1 to 13-n connected with PBX 12 provided on the support center side. The PBX 12 is a telephone call switching device provided indoors.

As shown by symbol (B) in FIG. 1, a PC 17 provided on the user side is connected to a communication line 20 through a router 18. PCs 21-1 to 21-n and database 22 provided on the support center side are connected to the communication line 20. Routers 18 and 23 are route setting devices, respectively. The router 23 is connected to web server 24, which provides a service of remote diagnosis and repair.

As shown in FIG. 1, the PC 17 provided on the user side is configured with a BIOS ROM 31, video controller 32, video memory 32a, monitor 33, audio I/O 34, speaker 34R, speaker 34L, main memory 35, HDD 36, controller 37, keyboard I/O 38a, mouse I/O 38b, USB I/O 38c, keyboard 39, mouse 40, DVD/CD drive 41, and LAN controller 42.

The BIOS ROM 31 stores a group of programs controlling peripheral devices connected to the PC 17, such as a disk drive, keyboard, mouse, USB, and video card. The BIOS ROM 31 provides OS (operating system) and application software with basic input/output programs related to these devices.

The video controller 32 reads image data stored in the video memory 32a and generates image signals to display thereof on the monitor 33. The audio I/O 34 outputs audio signals from the speakers 34R and 34L.

The main memory 35 stores OS and application software transferred from the HDD 36, which are executed by the controller 37. The keyboard I/O 38a obtains key information inputted through the keyboard 39 and sends interrupting signals to the controller 37. The mouse I/O 38b obtains positional information and click information inputted through the mouse 40, sending interrupting signals to the controller 37.

The USB I/O 38c is one standard of data transmission path, which connects the personal computer 17 with peripheral devices. The DVD/CD drive 41 executes data transfer with DVD-ROM and CD-ROM, performing recording/replaying video and recording/replaying data. For example, a diagnostic program, application software including programs for diagnosing the personal computer 17, and the like are stored on the DVD-ROM and CD-ROM.

The LAN controller 42 controls interactive communication with the router 18 through LAN (LOCAL AREA NETWORK).

The HDD 36 stores a diagnostic program related to a plurality of functional blocks and image data in a program storing area 36a, in which OS and application software are stored. The OS and application software read through the controller 37 are transferred to the main memory 35.

The HDD 36 includes a program storing area 36a, a diagnostic item table 36b, a diagnostic result table 36c, and a code conversion table 36d. The program storing area 36a stores application software including a plurality of diagnostic programs to be used to diagnose contents established for software related to a plurality of functional blocks provided on the PC 17. The diagnostic item table 36b stores in advance class identifications corresponding to the diagnostic programs, respectively, such that the priority of the diagnostic programs is in descending order. The diagnostic result table 36c stores the diagnostic result that indicates the environmental information including a condition established for software, whether the contents established for the software are valid, and a type of an operating system, and the environmental condition including a result of operation. The code conversion table 36d stores a plurality of diagnostic codes which correspond one-to-one with a set of a plurality of types of result data indicating an operating condition of a functional block.

The controller 37 controls each of the above-mentioned portions according to the programs of application software loaded to the main memory 35 from the HDD 36. A repair program for repairing faults which may occur in the PC 17 is stored in the HDD 36.

### Operation of PC 17 on User Side

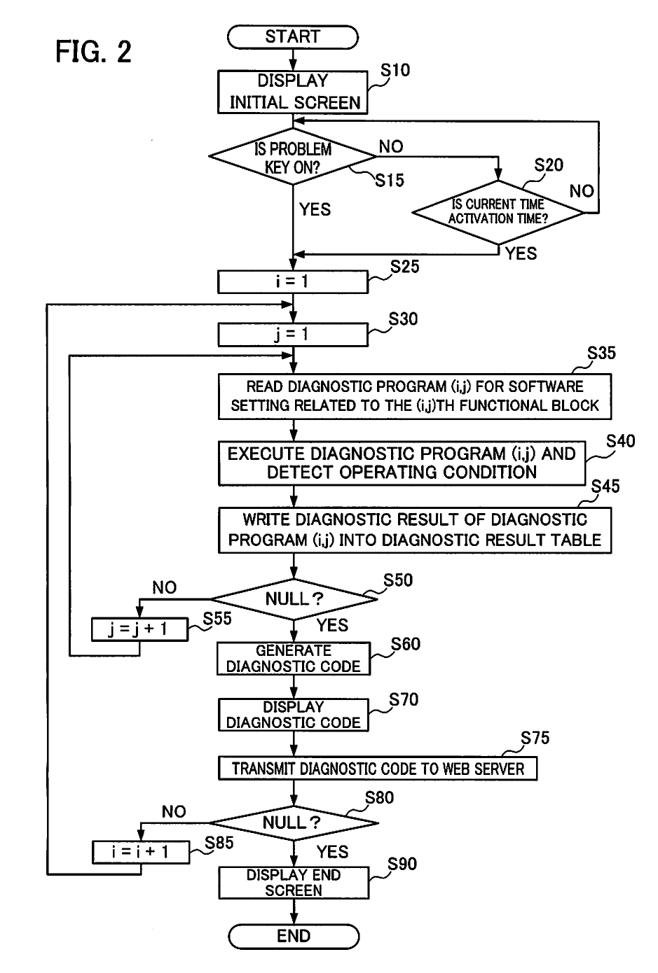

Next, operation of a fault diagnosis system according to a first embodiment is explained with reference to a flowchart shown in FIG. 2. A program executing the flow is loaded from the program storage area 36a to the main memory 35 by the controller 37, which sequentially executes each step of the flow according to the program.

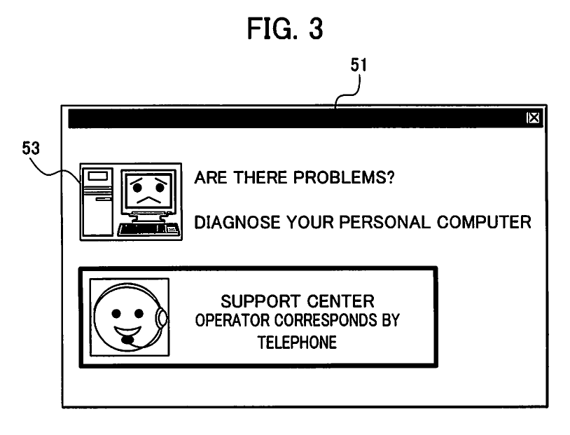

Initially, in Step S10, the controller 37, upon activation, generates an initial screen, allowing it to be displayed on the monitor 33 through the video controller 32. As a result, as shown in FIG. 3, an initial screen 51 is displayed on the monitor 33.

Subsequently, in Step S15, the controller 37 determines whether the mouse is clicked on a problem key 53 on the initial screen 51 displayed on the monitor 33. In a case where the mouse is not clicked on the problem key 53, the controller reads a current time from a clock (not shown), and determines whether the current time has reached an automatic activation time of the fault diagnosis system set by the user in advance. Processing is advanced to Step S25 in a case where the current time has reached the activation time. On the other hand, in a case where the current time has not yet reached the activation time, the processing of Steps S15 and S20 is repeated.

Here, in a case where the problem key 53 is clicked, or in a case where the current time has reached the activation time, the processing advances to Step S25, and the controller 37 sets the class number i to 1 (i=1). Subsequently, in Step S30, the controller 37 sets the class number j to 1 (j=1). In this connection, the class number i indicates the number assigned to a group of diagnostic items that share the substantially common priority, and the class number j indicates the individual order of priority assigned among the group of the class number i.

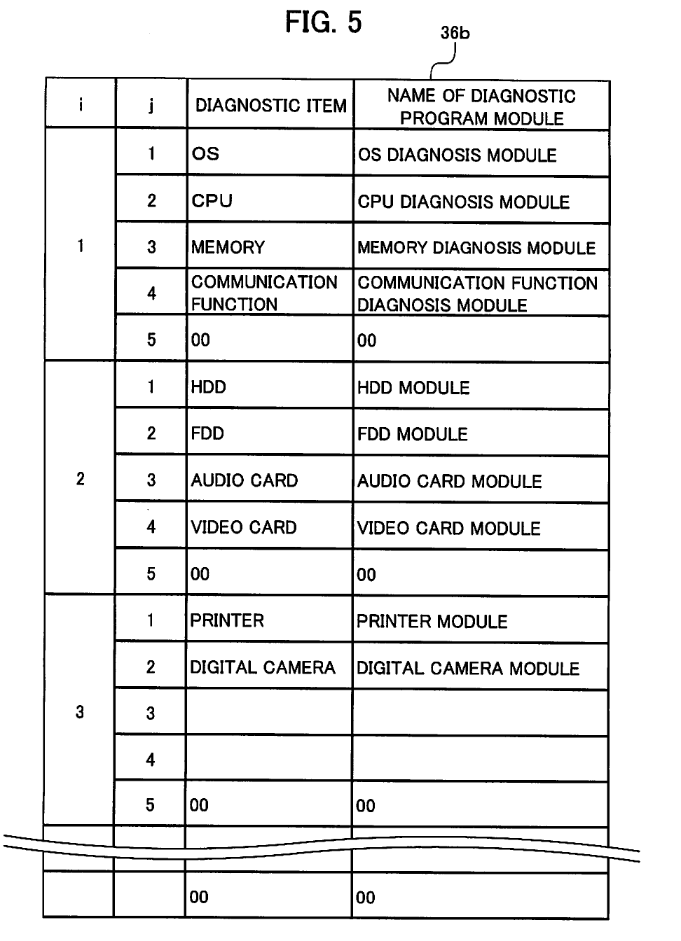

Subsequently, in Step S35, the controller 37 reads a diagnostic program (i,j) for a software setting related to the class number (i,j) of functional block provided in the diagnostic item table 36b. Here, what is initially read upon activation of this software is, for example, as shown in FIG. 5, an OS diagnosis module set as the diagnostic program (1,1) in the diagnostic item table 36b.

The OS diagnosis module diagnoses types and version numbers of OS. In a case where the OS of PC 17 is, for example, Microsoft Windows™: Vista™, XP™, 2000™, ME™, Linux™, Mac OS™, or the like, the OS diagnosis module may output result data (k) indicating a diagnostic result of the OS version of interest.

Moreover, the diagnostic item table 36b is configured to store diagnostic items each added with a class number (i,j) so that the priority of the diagnostic items related to the diagnostic program is set in descending order.

Subsequently, in Step S40, the controller 37 executes the diagnostic program (i,j) thus read, detecting the operating condition related to the functional block of class number (i,j).

Subsequently, in Step S45, the controller 37 writes result data (k) obtained by executing the diagnostic program (i,j) into the diagnostic result table 36c, which is a storage area assigned to the HDD 36.

Moreover, in the diagnostic result table 36c, execution history is stored, in which the information related to execution time is added to a plurality of types of result data (k) indicating a diagnostic result after executing a single diagnostic program (i,j) and a class number (i,j) that corresponds to the result data (k).

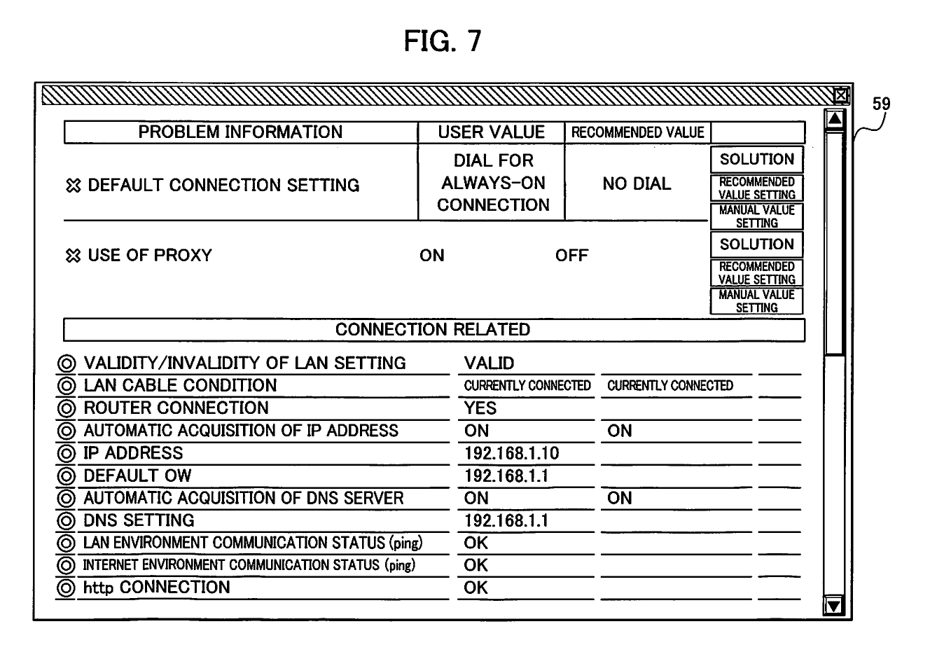

An operating condition table 59 is explained with reference to FIG. 7. FIG. 7 depicts the operating condition table 59 related to a functional block. In addition, as shown in FIG. 7, it may be that the operating condition table 59 is generated, which indicates a diagnostic result based on the operating condition detected in Step S40.

Subsequently, in Step S50, the controller 37 determines whether the diagnostic program (i,j) read from the program storage area 36a has a value “00” indicating NULL. In a case where the diagnostic program (i,j) thus read is not NULL, the processing advances to Step S55. On the other hand, in a case where the diagnostic program (i,j) thus read is NULL, the processing advances to Step S60.

Subsequently, in Step S55, the controller 37 increments the class number j to be an updated number of j+1. Then, the flow returns to Step S35 and repeats the processing of the abovementioned Steps S35 to S50.

On the other hand, in Step S60, the controller 37 performs processing for generating a diagnostic code, thereby generating diagnostic codes corresponding to a plurality of types of result data (k) obtained as a result of executing the diagnostic program (i,j) and adding the class number (i,j) to the diagnostic code thus generated. As a result, the class number (i,j) is added to the diagnostic code thus generated, and stored in a storage area provided in the HDD 36.

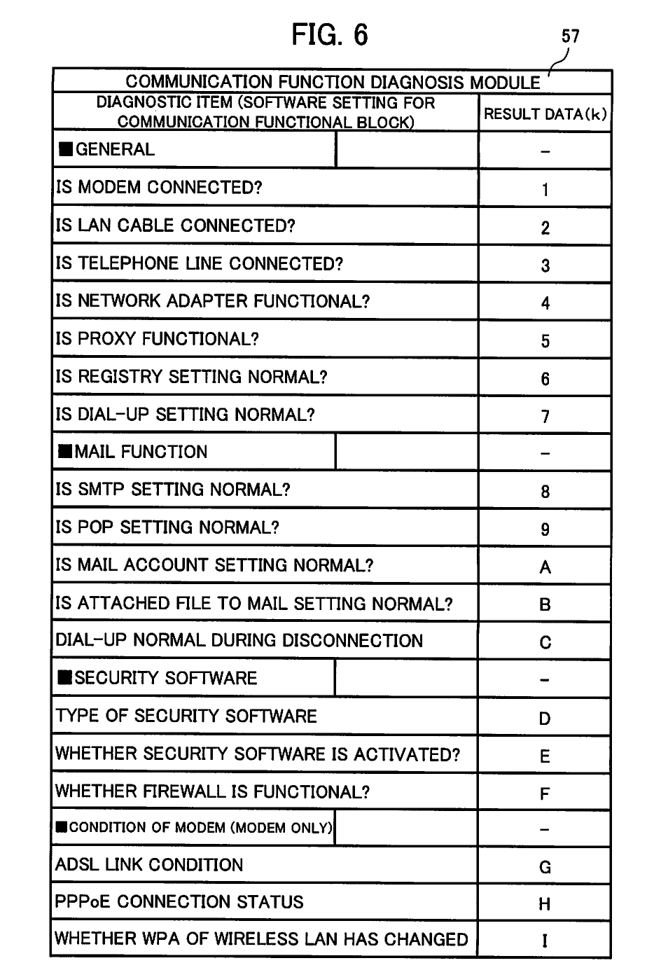

Here, as an example, the foregoing processing for generating a diagnostic code related to a communication functional block is explained with reference to FIG. 6. FIG. 6 is a diagnostic result table 57 indicating each detailed diagnostic item related to a module for diagnosing a communication function, which is used for diagnosing the communication functional block, and a plurality of types of result data (k) obtained as a result of executing the diagnostic program (i,j). The diagnostic result table 57 is stored in a storage area in the HDD 36 as a result of executing the module. Similarly, diagnostic result tables of the diagnostic modules that correspond to a plurality of different functional blocks are stored in the storage area in the HDD 36 as a result of executing each module.

On the other hand, a plurality of diagnostic codes is stored in the code conversion table 36d in the HDD 36. The plurality of diagnostic codes corresponds one-to-one with a set of a plurality of types of result data indicating an operating condition of a communication functional block. Moreover, the result data (k) is data indicating the environmental information including whether it is valid or invalid for a single detailed diagnostic item and a type of an operating system, or the environmental condition such as an operation result. Therefore, it goes without saying that it may be possible that a plurality of diagnostic results is generated for a single detailed diagnostic item.

The controller 37 executes encoding processing of a plurality of types of result data as a set of keys by referencing the code conversion table 36d. That is, the controller 37 reads a single diagnostic code that matches a set of a plurality of types of result data (k) related to the module for diagnosing a communication function from the code conversion table 36d so as to generate the diagnostic code, storing the diagnostic code in a storage area in the HDD 36.

The diagnostic code is composed of a 2-byte code, that is, a 16-bit code. Since it is possible to assume different values in 2¹⁶ ways for a single diagnostic code, the diagnostic code can be shortened with extremely high efficiency, compared with expression of the diagnostic result using a combination of decimal numerals. As a result, the volume of information can be decreased when the diagnostic code is transmitted. Alternatively, for the 2-byte code used as the diagnostic code, character codes such as Japanese syllabary characters, numerals, and alphabets may be used. In addition, it may be possible to exclude specific characters that make people confused visually among those character codes.

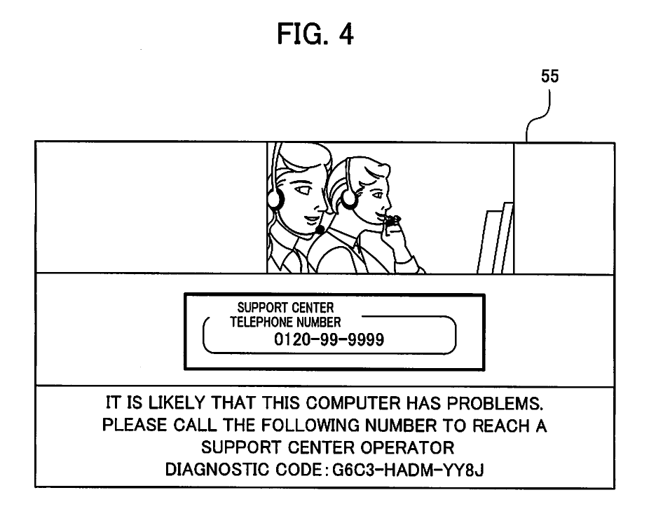

Subsequently, in Step S70, the controller 37 causes the diagnostic code thus generated to be displayed. That is, the controller 37 reads the diagnostic code stored in the storage area provided in the HDD 36 and causes the diagnostic code to be displayed on the monitor 33 through the video controller 32. As a result, as shown in FIG. 4, the message screen 55 including messages of “IT IS LIKELY THAT THIS COMPUTER HAS PROBLEMS. PLEASE CALL THE FOLLOWING NUMBER TO REACH A SUPPORT CENTER OPERATOR” and “DIAGNOSTIC CODE: G6C3-HADM-YY8J” is displayed on the monitor 33.

It is because four general diagnostic items are included in a group indicated by a single class number i that diagnostic codes related to the four general diagnostic items in the single group are displayed. However, the present invention is not limited to the abovementioned case, but it may be alternatively configured to display diagnostic codes related to the entirety of a plurality of groups.

With the diagnostic program for a software setting with high-ranking priority, which displays the diagnostic code in a case where the diagnostic result indicating the environmental information including whether the contents established for software is valid or invalid and a type of a operating system, or the environmental condition including an operation result has been obtained, it is possible to notify a fault of a general diagnostic item earlier the higher its priority is.

Subsequently, in Step S75, the controller 37 reads the diagnostic code stored in the storage area provided in the HDD 36, and transmits the diagnostic code thus read to the web server 24 provided on the support center side via the LAN controller 42, the router 18, the communication line 20, and the router 23.

Subsequently, in Step S80, the controller 37 determines whether the diagnostic program (i,j) thus read from the HDD 36 has a value “00” indicating NULL. In a case where the diagnostic program (i,j) thus read is not NULL, the processing advances to Step S85. On the other hand, in a case where the diagnostic program (i,j) is NULL, the processing advances to Step S90.

Subsequently, in Step S85, the controller 37 increments the class number i to i+1, and then returns the flow to Step S30 and repeats the abovementioned processing of Steps S30 to S80.

Subsequently, in Step S90, the controller 37 generates an end screen indicating that the processing has ended, and displays thereof on the monitor 33 through the video controller 32. As a result, the end screen is displayed on the monitor 33.

The fault diagnosis system of the present invention performs processing including: storing the diagnostic programs that are each provided in advance with the class number in order of descending priority thereof; updating the class number in the order of priority; reading out a diagnostic program associated with the class number from the program storing area 36a at each time of updating; causing the controller to execute the diagnostic program; and causing the monitor 33 to display a code indicating a result of a diagnosis as a result of the execution of the diagnostic program. In this way, the fault diagnosis system can notify a fault of a general diagnostic item earlier the higher its priority is.

### Operation of Web Server on Support Center

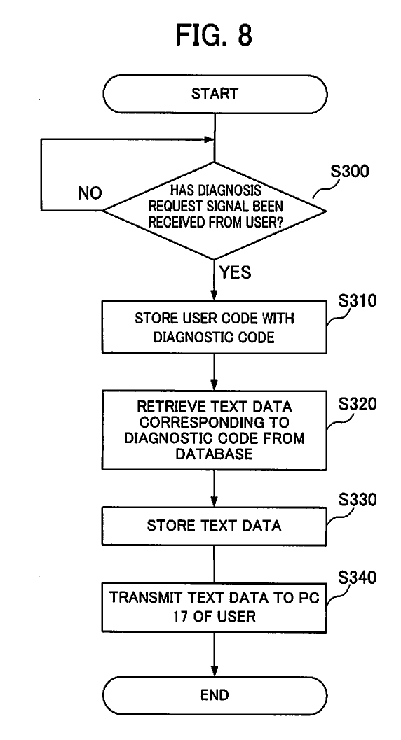

Next, an operation of the web server 24 is explained with reference to a flowchart shown in FIG. 8. The flow is loaded as a program from a hard disk to a main memory by the controller provided on the web server 24, and the controller executes each step of the flow sequentially according to the program.

Initially, in Step S300, the controller of the web server 24 determines whether a diagnosis request signal is received from a user via a communication controller. In a case where the diagnosis request signal is not received, the processing is returned to Step S300 and repeated. On the other hand, in a case where the diagnosis request signal is received, the processing advances to Step S310.

Subsequently, in Step S310, the controller adds a diagnostic code to a user code received from the PC 17 by the communication controller, and temporarily stores them in the main memory.

Subsequently, in Step S320, the controller reads the diagnostic code stored in the main memory one by one, and searches the database 22 for text data corresponding to the diagnostic code.

Subsequently, in Step S330, the controller temporarily stores the text data obtained by retrieving the database 22 in the main memory.

Subsequently, in Step S340, the controller reads the text data thus obtained from the main memory and transmits it to the PC 17 via the communication controller. In this connection, the text data includes contents related to an instruction for changing the contents of setting of the PC 17 on the user side.

Thus, a diagnostic code indicating a diagnostic result obtained after executing a diagnostic program in the PC 17 is transmitted to the PC 21 provided at the support center, and then the PC 21 transmits text data of solution corresponding to the diagnostic code to the user PC 17. Therefore, if the PC 17 on the user side is configured to receive the text data of solution corresponding to the diagnostic code from the PC 21, the user can perform a setting operation based on the text date so as to repair a fault occurring at the user terminal.

With the fault diagnosis system of the present invention, which transmits the diagnostic code to the PC 21 at the support center only in a case where the diagnostic result indicating the environmental information including whether the contents established for software related to functional blocks are valid or invalid and a type of a operating system, or the environmental condition including an operation result has been obtained, it is possible to shorten time required to repair the fault occurring at the user terminal.

### Operation of PC 21-n of Support Center

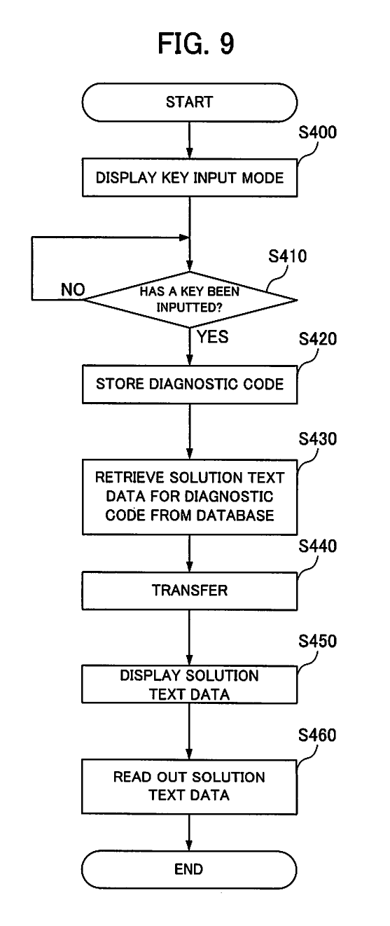

Next, the operation of PC 21-n is explained with reference to a flowchart shown in FIG. 9. The flow is loaded as a program from a hard disk to a main memory by the controller provided on PC 21-n, and the controller executes each step of the flow sequentially according to the program.

In a case where the communication function provided on the PC 17 on the user side is valid or invalid, the diagnostic code of the PC 17 as shown in FIG. 4 is displayed on the monitor 33. Then, the user calls the support center according to the message screen, and tells the diagnostic code to an operator.

Initially, in Step S400, the controller displays that a current mode is a key input mode. As a result, an input area for inputting a diagnostic code is displayed and provided to the operator. At this time, the operator inputs the diagnostic code communicated through the telephone from the user to the input area displayed on the monitor.

Subsequently, in Step S410, the controller determines whether there is any input from the keyboard to the input area displayed on the monitor. In a case where there is no input, the processing returns to Step S410 and is repeated. On the other hand, in a case where there is an input, the processing advances to Step S420.

Subsequently, in Step S420, the controller stores a diagnostic code inputted from the keyboard in the main memory.

Here, in the PC 21-n of the support center is stored a table of reverse conversion for a code which stores a plurality of sets each including a plurality of types of diagnostic result data that correspond one-to-one with a single diagnostic code.

In Step S430, the controller decomposes the diagnostic code thus inputted for each 2-byte code to reproduce a plurality of diagnostic codes, and causes them to be temporarily stored in the main memory. Then, the controller reads the diagnostic codes stored in the main memory one by one, and executes decoding of the diagnostic codes by referencing the table of reverse conversion for a code, and the like. The controller reproduces a plurality of types of result data corresponding to the diagnostic code based on the code reverse conversion table, and searches the database 22 for the text data of solution corresponding to the result data. Here, the text data for solution includes, for example, an instruction to read a repair program from the HDD 36 of the user terminal so as to execute the repair program thus read as a repair instruction to repair a fault occurring at the user terminal, an instruction to change the contents established for the PC 17 on the user side, and the like.

Subsequently, in Step S440, the controller transmits an instruction of transferring data, to the database 22 via the communication controller. According to the instruction, the database 22 transfers the text data of solution corresponding to the diagnostic code to the PC 21-n.

Subsequently, in Step S450, the controller displays on the monitor the text data of solution corresponding to the diagnostic code received from the database 22. Here, an operator may read out the text of solution displayed on the monitor, and thus can convey the contents of the text of solution to the telephone 11 via the telephone line 14 from the telephone 13-n.

Subsequently, in Step S460, the controller transmits the text data of solution corresponding to the diagnostic code received from the database 22 to an audio processing portion to perform reading out of the text data, outputting the content of the text converted into an audio signal to the speaker. If an audio output of the audio processing portion is supplied to a microphone of a receiving device, the content of the text can be conveyed to the telephone 11 on the user side. Here, if the user operates the PC 17 according to the content of the audio instruction, the user can deal with specific problems such as a setting or a connection condition between the PC 17 and the router 18, and the like. This can help solve the problems occurring on the PC 17.

Thus, even if the PC 17 is not connected to a network, the user can tell the diagnostic code to an operator in the support center through the telephone. Therefore, the user can deal with specific problems such as a setting or a connection condition by operating the PC 17 according to the content of the audio instructions provided by the operator through the telephone.

Although an operating condition of the functional block is detected upon startup of the user terminal according to the present embodiment, the present invention is not limited thereto. Alternatively, an operating condition of the functional block may be detected upon the initiation of the program at the time when a program is installed at the user terminal or the user finds a fault occurring on the user terminal during operation.

### Second Embodiment

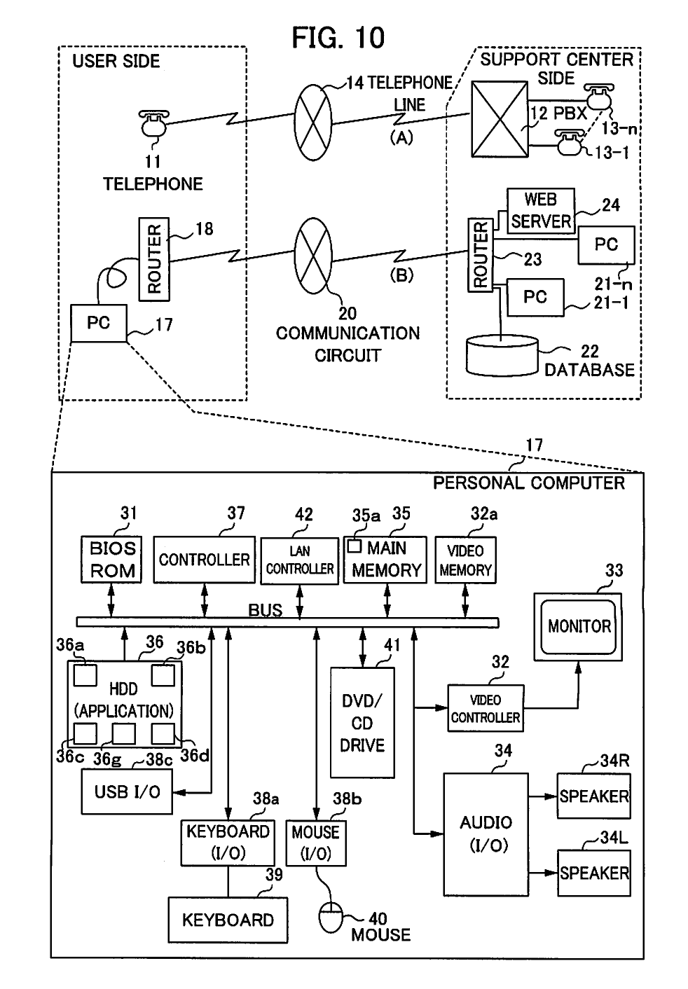

FIG. 10 is a system configuration diagram showing a schematic configuration applied to a fault diagnosis system according to a second embodiment of the present invention. In the second embodiment, as shown in FIG. 10, a conversion table 36g is newly provided to the HDD 36.

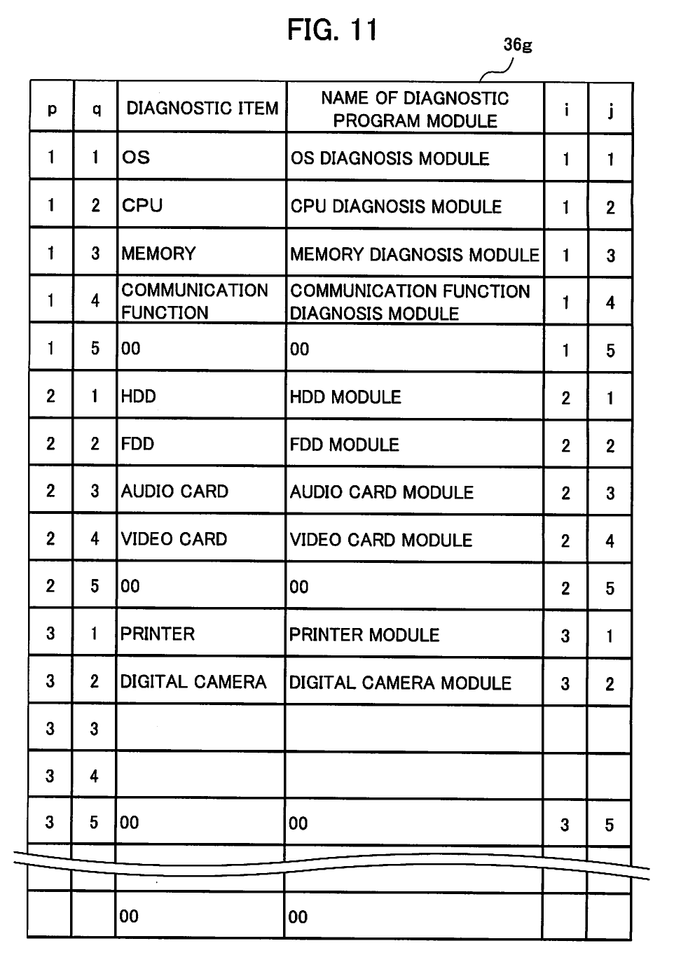

In the first embodiment of the present invention, the controller 37 reads a diagnostic program (i,j) having the class number (i,j) set in the diagnostic item table 36b from the program storing area 36a, and executes it. In contrast, as shown in FIG. 11, in the second embodiment of the present invention, a conversion table 36g is provided to the HDD 36, which stores a new class number (p,q) to which a second order of priority different from that of the first embodiment is assigned on demand of a user with respect to the class number (i,j) stored in the diagnostic item table 36b. More specifically, the conversion table 36g is composed of a class number (p,q), a diagnostic item, a name of diagnostic program module, and a class number (i,j).

Here, the class number (p,q) is organized such that an arbitrary diagnostic item is correlated with q ranging from 1 to 4, for example. If q is 5, “00” indicating NULL is assigned. In addition, the original class number (i,j) set in advance is assigned to the diagnostic item and the name of diagnostic program module, respectively.

### Operation of PC 17 on User Side

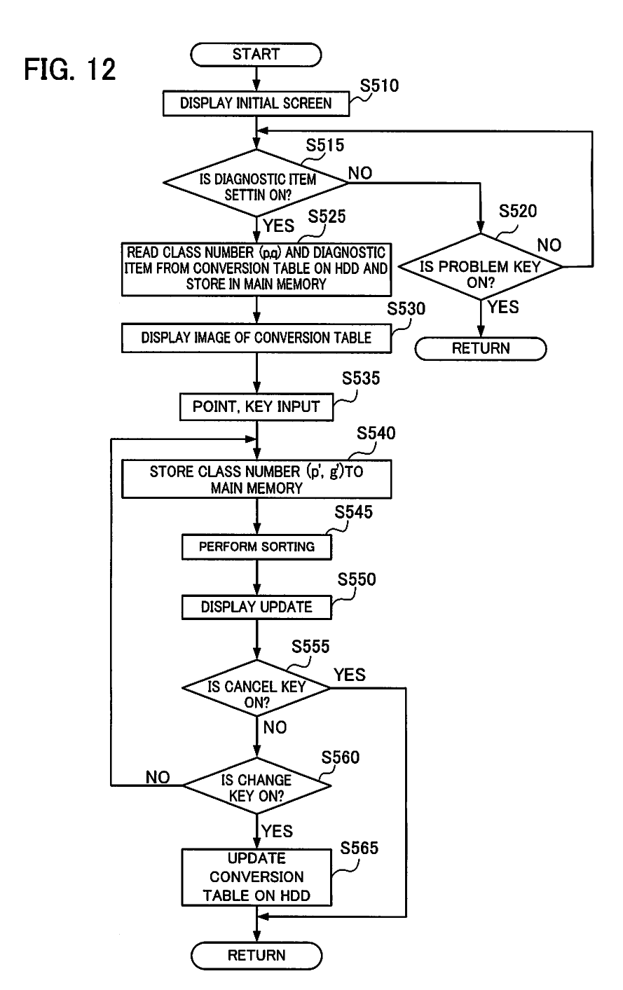

Next, an operation of a fault diagnosis system according to a second embodiment is explained with reference to a flowchart shown in FIG. 12. The flow is loaded as a program from the program storage area 36a to the main memory 35 by the controller 37, and the controller 37 sequentially executes each step of the flow according to the program.

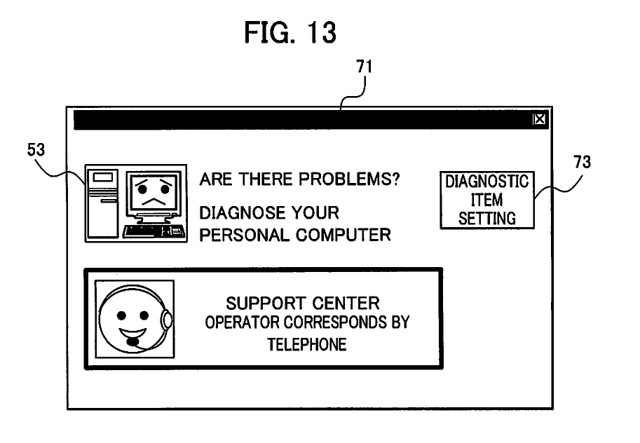

Initially, in Step S510, the controller 37 generates an initial screen upon activation and displays thereof on the monitor 33 through the video controller 32. As a result, as shown in FIG. 13, an initial screen 71 is displayed on the monitor 33.

Subsequently, in Step S515, the controller 37 determines whether a mouse is clicked on a key 73 for setting a diagnostic item on the initial screen 71 displayed on the monitor 33. In a case where the mouse is not clicked on the key 73, the processing advances to Step S520, and then the controller 37 determines whether the mouse is clicked on a problem key 53 of the initial screen 71 displayed on the monitor 33. In a case where the mouse is not clicked on the problem key 53, the flow is returned to Step S515 and the processing of Steps S515 and S520 is repeated.

On the other hand, in Step S520, in a case where the mouse is clicked on the problem key 53, the processing is advanced to that of the main routine as shown in FIG. 2; however, an explanation thereof is omitted here.

On the other hand, in a case where the mouse is clicked on the key 73 in Step S515, the processing advances to Step S525, and the controller 37 reads a plurality of sets of data including a class number (p,q) and a diagnostic item from the conversion table 36g, and stores thereof as a conversion table 35a in the main memory 35.

Subsequently, in Step S530, the controller 37 reads data including a class number (p,q) and a diagnostic item of the conversion table 35a from the main memory 35, generating a screen image for setting diagnostic item using the class number (p,q) and the diagnostic item. In this way, the controller 37 sends signals related to the screen image to the video controller 32, which causes the monitor 33 to display the screen image.

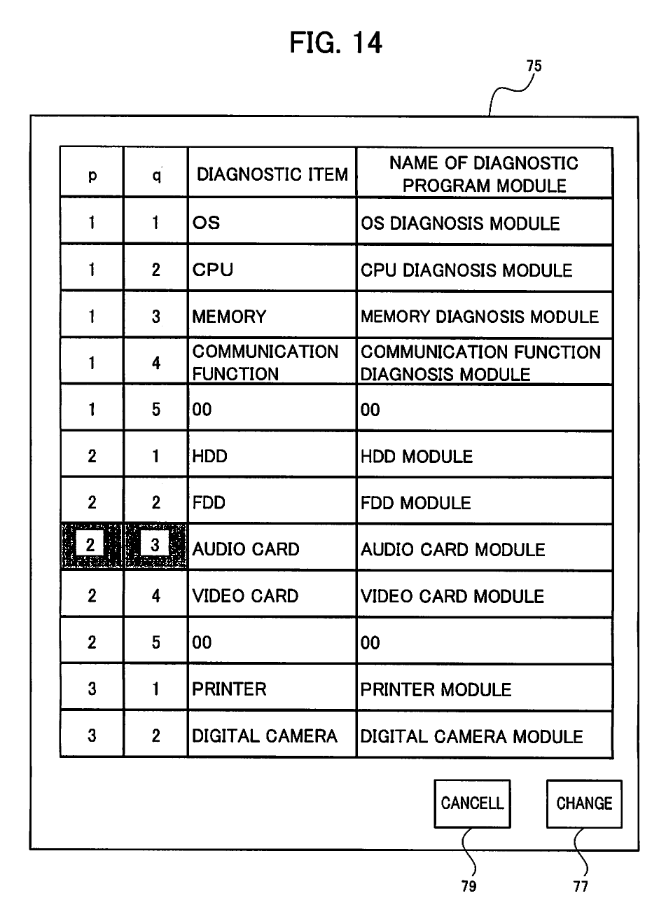

As a result, as shown in FIG. 14, for example, a screen 75 for setting a diagnostic item is displayed on the monitor 33. A user can instruct change of the class number (p,q) displayed on the monitor 33 by using the keyboard 39 or the mouse 40. Moreover, in FIG. 14, a display color of the class number (2,3) of a position pointed by way of the mouse 40 is inverted.

Subsequently, in Step 535, the controller 37 acquires the class number (p,q) shown at the pointing position on the screen 75 indicated through the keyboard 39 or the mouse 40, and inputs a new class number (p′,q′) to replace the class number (p,q). For example, in a case where a user changes the class number (2,3) at the pointing position shown in FIG. 14 to (3,1) using the keyboard 39, the controller 37 obtains the class number (2,3) indicating the pointing position and the new class number (3,1).

Subsequently, in Step S540, the controller 37 stores the class number (p,q) and the new class number (p′,q′) in a temporary memory area of the main memory 35.

Subsequently, in Step S545, based on the class number (p,q) and the new class number (p′,q′), the controller 37 rearranges, by sorting, data of each row including a diagnostic item in the conversion table 35a of the main memory 35. The controller 37 performs changing of the order of priority, except for the new class number (p′,q′), updating the conversion table 35a of the main memory 35. In addition, since the diagnostic item indicated by the class number (2,5) is NULL, it is not subjected to sorting processing.

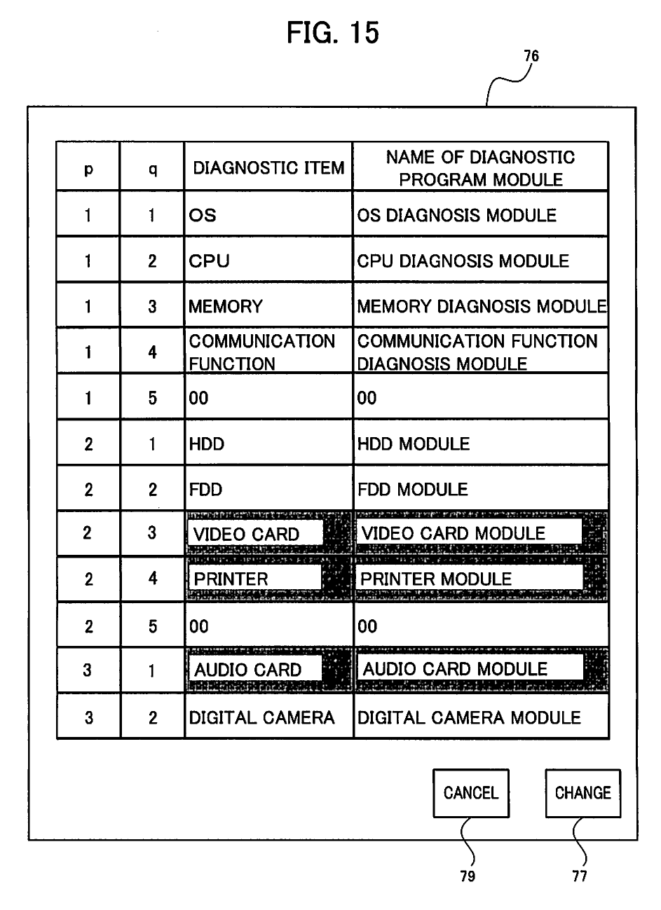

Subsequently, in Step S550, the controller 37 reads the data composed of the class number (p,q) and the diagnostic item in the conversion table 35a after the above-mentioned update from the main memory 35. The controller 37 generates a screen image for setting a diagnostic item using the class number (p,q) and the diagnostic item, sending signals indicating the screen image to the video controller 32, which causes the monitor 33 to display the screen image. As a result, as shown in FIG. 15, for example, a screen 76 for setting a diagnostic item is displayed on the monitor 33. As shown in FIG. 15, for example, the diagnostic item “video card” is moved to the class number (2,3), the diagnostic item “printer” is moved to the class number (2,4), and the diagnostic item “audio card” is moved to the class number (3,1).

Subsequently, in Step S555, the controller 37 determines whether the mouse is clicked on a cancel key 79 of the screen 76 displayed on the monitor 33. In a case where the mouse is clicked on the cancel key 79, the controller 37 terminates the processing. On the other hand, in a case where the mouse is not clicked on the cancel key 79, the processing advances to Step S560, and the controller 37 determines whether the mouse is clicked on a change key 77 of the screen 76 displayed on the monitor 33. In a case where the mouse is not clicked on the change key 77, the flow returns to Step S535, and the above processing is repeated. On the other hand, in a case where the mouse is clicked on the change key 77, the flow advances to Step S565.

Subsequently, in Step S565, the controller 37 reads the data including the class number (p,q) and the diagnostic item in the conversion table 35a after the abovementioned update from the main memory 35, and performs overwrite processing so as to update the conversion table 36g provided in the HDD 36.

### Operation of PC 17 on User Side

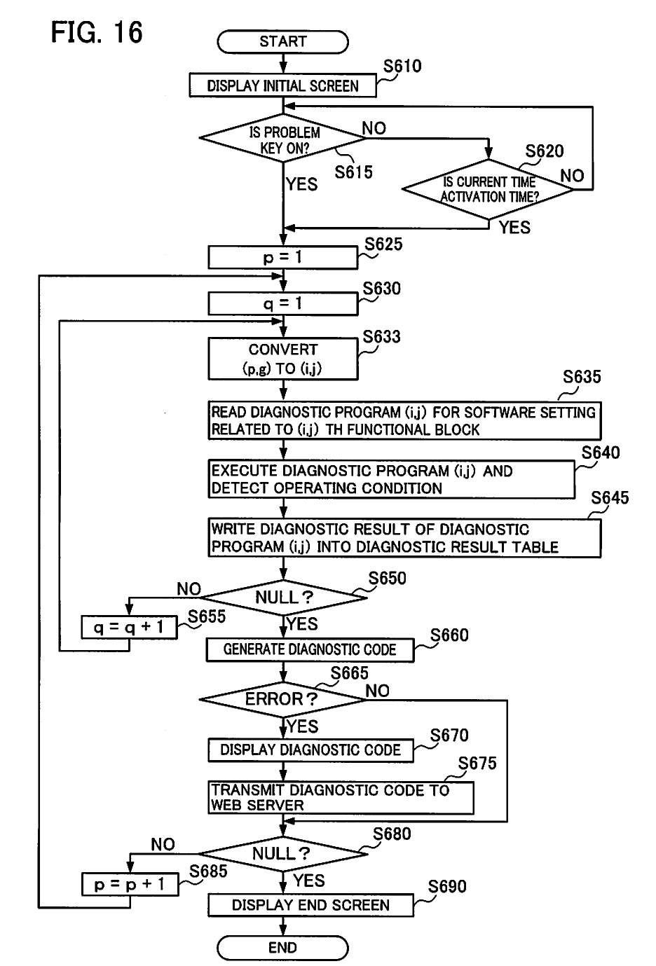

Next, an operation of a fault diagnosis system according to a second embodiment is explained with reference to a flowchart shown in FIG. 16. The flow is loaded as a program to the main memory 35 from the program storing area 36a by the controller 37, and the controller 37 sequentially executes each step of the flow according to the program.

Initially, in Step S610, the controller 37 generates an initial screen upon startup, and displays thereof on the monitor 33 through the video controller 32. As a result, as shown in FIG. 13, an initial screen 71 is displayed on the monitor 33.

Subsequently, in Step S615, the controller 37 determines whether a mouse is clicked on a problem key 53 of the initial screen 71 displayed on the monitor 33. Here, in a case where the mouse is not clicked on the problem key 53, the controller reads a current time from a clock (not shown), and determines whether the current time has reached an automatic activation time of the fault diagnosis system set by the user in advance. In a case where the current time has reached the activation time, processing advances to Step S625. On the other hand, in a case where the current time has not reached the activation time, the processing of Steps S615 and S620 is repeated.

Here, in a case where the problem key 53 is clicked or the current time has reached the activation time, processing advances to Step S625. Here, the controller 37 sets a class number p to 1 (p=1). Subsequently, in Step S630, the controller 37 sets a class number q to 1 (q=1).

Subsequently, in Step S633, the controller 37 refers to the conversion table 36g which has been changed by the user, and reads a class number (i,j) that corresponds to the class number (p,q).

Subsequently, in Step S635, the controller 37 reads a diagnostic program (i,j), which is used for setting a software related to a functional block corresponding to the class number (i,j) set in the diagnostic item table 36b. Here, what is initially read upon activation of this software is, for example, as shown in FIG. 5, an OS diagnosis module set as the diagnostic program (1,1) on the diagnostic item table 36b.

Moreover, the diagnostic item table 36b is configured to store a diagnostic item related to a diagnostic program with a class number (i,j) in descending order of priority.

Subsequently, in Step S640, the controller 37 executes the diagnostic program (i,j) thus read to detect the operating condition related to the functional block corresponding to the class number (i,j).

Subsequently, in Step S45, the controller 37 writes result data (k) obtained by executing the diagnostic program (i,j) into the diagnostic result table 36c, which is a storage area assigned to the HDD 36.

Moreover, a plurality of types of result data (k) indicating a diagnostic result after executing a diagnostic program (i,j) and a class number (i,j) corresponding to the result data (k) are stored as an execution history along with the information related to the time of execution in the diagnostic result table 36c.

An operating condition table 59 is explained with reference to FIG. 7. FIG. 7 is an operating condition table 59 related to a functional block. In addition, as shown in FIG. 7, an operating condition table 59 may be generated that indicates a diagnostic result based on the operating condition detected in the Step S640.

Subsequently, in Step S650, the controller 37 determines whether the diagnostic program (i,j) read from the program storage area 36a has a value “00” indicating NULL. In a case where the diagnostic program (i,j) thus read is not NULL, the processing advances to Step S55. On the other hand, in a case where the diagnostic program (i,j) thus read is NULL, the processing advances to Step S660.

Subsequently, in Step S655, the controller 37 increases a class number q to be an updated number of q+1, then returns the flow to Step S635, and repeats the processing of the abovementioned Steps S635 to S650.

On the other hand, in Step S660, the controller 37 performs processing for generating a diagnostic code. The controller 37 generates a diagnostic code that corresponds to a plurality of types of result data (k) obtained by executing the diagnostic program (i,j), and assigns a class number (p,q) to the diagnostic code thus generated. As a result, the class number (p,q) is added to the diagnostic code, and stored in the storage area provided in the HDD 36. Since the processing for generating a diagnostic code is performed similarly to that of the first embodiment, an explanation thereof is omitted.

Subsequently, in Step S665, the controller 37 determines whether there is an error as a result of the above processing for generating a diagnostic code. Here, in a case where there is an error, the processing advances to Step S670. On the other hand, in a case where there is not an error, the processing advances to Step S680.

Subsequently, in Step S670, the controller 37 causes the diagnostic code thus generated to be displayed. That is, the controller 37 reads the diagnostic code stored in the storage area provided on the HDD 36, and displays the diagnostic code on the monitor 33 through the video controller 32. As a result, as shown in FIG. 4, the message screen 55 that includes messages of “IT IS LIKELY THAT THIS COMPUTER HAS PROBLEMS. PLEASE CALL THE FOLLOWING NUMBER TO REACH A SUPPORT CENTER OPERATOR” and “DIAGNOSTIC CODE: G6C3-HADM-YY8J” is displayed on the monitor 33.

With the diagnostic program for setting of a software with high-ranking priority arbitrarily set by a user, which displays the diagnostic code in a case where the diagnostic result indicating the environmental information including whether the contents established for software is valid or invalid and a type of a operating system, or the environmental condition including an operation result has been obtained, it is possible to notify a fault of a general diagnostic item earlier the higher its priority set by the user is.

Subsequently, in Step S675, the controller 37 reads the diagnostic code stored in the storage area provided in the HDD 36 and transmits the diagnostic code thus read to the web server 24 provided at the support center via the LAN controller 42, the router 18, the communication line 20, and the router 23.

Subsequently, in Step S680, the controller 37 determines whether the diagnostic program (i,j) thus read from the program storage area 36a has a value “00” indicating NULL. In a case where the diagnostic program (i,j) thus read is not NULL, the processing advances to Step S685. On the other hand, in a case where the diagnostic program (i,j) is NULL, the processing advances to Step S690.

Subsequently, in Step S685, the controller 37 increases a class number p to be an updated p+1, and returns the flow to Step S30, repeating the abovementioned processing of Steps S630 to S680.

Subsequently, in Step S690, the controller 37 generates an end screen image indicating the termination of processing, and displays the end screen image on the monitor 33 through the video controller 32. As a result, the end screen image is displayed on the monitor 33.

Along with the original class number, the new class number provided with the new order of priority, which can be set by a user independently of the original order of priority, is stored in the conversion table. The controller reads the new class number from the conversion table, causing the monitor to display it with the diagnostic item of a diagnostic program. The controller causes the new class number stored in the conversion table to be updated according to the instruction provided by a user. With the fault diagnosis system in which the controller causes the diagnostic program to be read according to the new class number set on demand of a user, it is possible to notify a fault earlier the higher the order of priority set by the user for the new class number is.

Thus, a diagnostic code indicating a diagnostic result obtained after executing a diagnostic program in the PC 17 is transmitted to the PC 21 provided at the support center, and then the PC 21 transmits text data of solution corresponding to the diagnostic code to the user PC 17. Therefore, if the PC 17 on the user side is configured to receive the text data of solution corresponding to the diagnostic code from the PC 21, the user can perform a setting operation based on the text date so as to repair a fault occurring at the user terminal.

With the fault diagnosis system of the present invention, which transmits the diagnostic code to the PC 21 at the support center only in a case where the diagnostic result indicating the environmental information including whether the contents established for software related to functional blocks are valid or invalid and a type of a operating system, or the environmental condition including an operation result has been obtained, it is possible to shorten time required to repair a fault occurring at a user terminal.

Moreover, in the present embodiment, the class number on the screen displayed by the monitor is changed by an instruction provided through the mouse. However, the present invention is not limited thereto. Alternatively, an operator on the support center side operates the PC 21 so as to instruct the change of a class number by remotely controlling the PC 17 on the user side via the communication line 20. Thus, a fault of a diagnostic item can be detected earlier the higher its order of priority selected by the support center is.

In addition, in the present embodiment, the class number on the screen is changed by way of the mouse operation by a user. However, the present invention is not limited thereto. For example, the information related to execution time is stored as an execution history in the diagnostic result table 36c in the HDD 36 along with a diagnostic code as a result of execution of a diagnostic program (i,j) and a class number (i,j) that corresponds to the diagnostic code. It may be alternatively possible to perform statistical processing for the past execution history stored in the diagnostic result table 36c, and to select a class number to be changed in order to increment more the order of priority of the class number of a diagnostic item the higher its rate of occurrence is. Thus, a fault of a diagnostic item can be detected earlier the higher its rate of occurrence is.

Furthermore, in the present embodiment, the class number on the screen is changed by way of an operation of the mouse on the PC 17 of the user side. However, the present invention is not limited thereto. For example, it may be alternatively possible to store the execution history in the database 22, which is periodically transferred from the diagnostic result table 36c of the PC 17 on the user side. The operator on the support center side operates the PC 21, performs statistical processing for the past execution history stored in the database 22 in order to increment more the order of priority of the class number of a diagnostic item the higher its rate of occurrence is. The operator remotely controls the PC 17 on the user side via the communication line 20 to select a class number to be changed. In this way, a fault of a diagnostic item can be detected earlier the higher its rate of occurrence is.

### Third Embodiment

A fault diagnosis system according to a third embodiment of the present invention is applied to the system configuration shown in FIG. 1. In the third embodiment of the present invention, in a case where a preferred diagnostic key is ON in the screen, the controller 37 reads a diagnostic program (i,j) related to a class number (i,j) set in the diagnostic item table 36b from the program storage area 36a and executes the diagnostic program (i,j).

### Operation of PC 17 on User Side

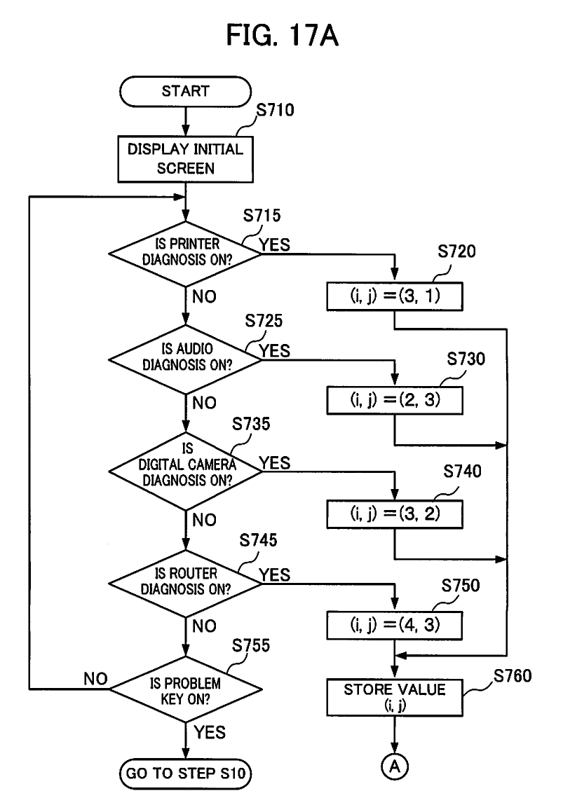

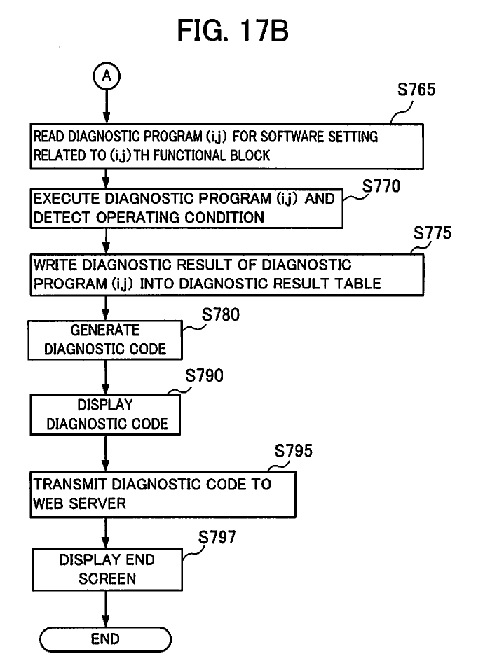

Next, an operation of a fault diagnosis system according to the third embodiment is explained with reference to a flowchart shown in FIG. 17. The flow is loaded as a program from the HDD 36 to the main memory 35 by the controller 37, which sequentially executes each step of the flow according to the program.

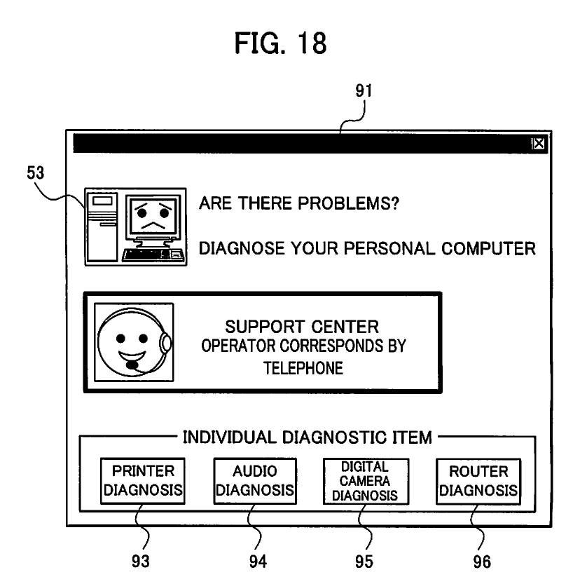

Initially, in Step S710, the controller 37 generates an initial screen image upon activation and displays thereof on the monitor 33 through the video controller 32. As shown in FIG. 18, on the monitor 33 are displayed, for example, an initial screen 91 including a printer diagnostic key 93, audio diagnostic key 94, digital camera diagnostic key 95, and router diagnostic key 96 as individual diagnostic items for diagnosing the contents for setting of software related to a functional block.

Subsequently, in Step S715, the controller 37 determines whether a mouse is clicked on the printer diagnostic key 93 as the individual diagnostic item on the initial screen 91 displayed on the monitor 33. In a case where the mouse is clicked on the printer diagnostic key 93, the processing advances to Step S720. Then, the controller 37 sets a class number (i,j) to (3,1) that corresponds to printer diagnosis, and the processing advances to Step S760.

In a case where the mouse is not clicked on the printer diagnostic key 93, the processing advances to Step S725. Then, the controller 37 determines whether the mouse is clicked on the audio diagnostic key 94 as the individual diagnostic items displayed on the monitor 33. In a case where the mouse is clicked on the audio diagnostic key 94, the flow advances to Step S730. Then, the controller 37 sets a class number (i,j) to (2,3) that corresponds to the audio diagnosis, and the processing advances to Step S760.

In a case where the mouse is not clicked on the audio diagnostic key 94, the processing advances to Step S735. Then, the controller 37 determines whether the mouse is clicked on the digital camera diagnostic key 95 as the individual diagnostic item displayed on the monitor 33. In a case where the mouse is clicked on the digital camera diagnostic key 95, the processing advances to Step S740. Then, the controller 37 sets a class number (i,j) to (3,2) that corresponds to the digital camera diagnosis, and the processing advances to Step S760.

In a case where the mouse is not clicked on the digital camera diagnostic key 95, the processing advances to Step S745. Then, the controller 37 determines whether the mouse is clicked on the router diagnostic key 96 as the individual diagnostic item displayed on the monitor 33. In a case where the mouse is clicked on the router diagnostic key 96, the processing advances to Step S750. Then, the controller 37 sets a class number (i,j) to (4,3) that corresponds to the router diagnosis, and the processing advances to Step S760.

In a case where the mouse is not clicked on the router diagnostic key 96, the processing advances to Step S755. Then, the controller 37 determines whether the mouse is clicked on the problem key 53. In a case where the mouse is not clicked on the problem key 53, the processing returns to Step S715 and the abovementioned processing is repeated. On the other hand, in a case where the mouse is clicked on the problem key 53, the processing advances to Step S11, and the processing after Step S10 in the first embodiment is repeated. However, an explanation thereof is omitted here.

Here, by the processing of the Steps S720, S730, S740, and S750, specific numerical data is set to the class numbers (i,j). Accordingly, in Step S760, the controller 37 stores in a temporary storage area in the main memory 35 the value of the class number (i,j) thus set.

Subsequently, in Step S765, the controller 37 reads a diagnostic program (i,j) for setting software related to the functional block corresponding to the class number (i,j) provided in the temporary storage area on the main memory 35.

Subsequently, in Step S770, the controller 37 executes the diagnostic program (i,j) thus read to detect the operating condition related to the functional block corresponding to the class number (i,j).

Subsequently, in Step S775, the controller 37 writes result data (k) obtained by executing the diagnostic program (i,j) into the diagnostic result table 36c which is a storage area assigned to the HDD 36.

Moreover, in the diagnostic result table 36c assigned to the HDD 36, the information related to the time of execution is stored as an execution history along with a plurality of types of result data (k) indicating a diagnostic result as a result of the execution of a diagnostic program (i,j) and a class number (i,j) that corresponds to the result data (k).

Subsequently, in Step S780, the controller 37 performs processing for generating a diagnostic code, thereby generating a diagnostic code that corresponds to the plurality of types of result data (k) obtained by executing the diagnostic program (i,j), and adds a class number (i,j) to the diagnostic code thus generated. As a result, the class number (i,j) is added to the diagnostic code thus generated, and stored in the storage area provided in the HDD 36.

Subsequently, in Step S790, the controller 37 causes the diagnostic code thus generated to be displayed. That is, the controller 37 reads the diagnostic code stored in the storage area provided on the HDD 36, and displays the diagnostic code on the monitor 33 through the video controller 32. As a result, as shown in FIG. 4, the message screen 55 that includes messages of “IT IS LIKELY THAT THIS COMPUTER HAS PROBLEMS. PLEASE CALL THE FOLLOWING NUMBER TO REACH A SUPPORT CENTER OPERATOR” and “DIAGNOSTIC CODE: G6C3-HADM-YY8J” is displayed on the monitor 33.

Subsequently, the processing advances to Step S795, the controller 37 reads the diagnostic code stored in the storage area provided in the HDD 36, and transmits the diagnostic code thus read to the web server 24 provided on the support center side via the LAN controller 42, the router 18, the communication line 20, and the router 23.

Moreover, in a case where a printer is subject to diagnosis, it may be preferable, but not necessary, to transmit the diagnostic code to the web server of the manufacturer of the printer. In this case, the URL address of the manufacturer of the printer as well as the class number (i,j) may be stored in the diagnostic item table 36b. In addition, in a case where an audio device, digital camera, router, and the like are subject to diagnosis, the URL address of the manufacturer as well as the class number (i,j) may be stored similarly.

Subsequently, in Step S797, the controller 37 generates an end screen image indicating the termination of processing, and displays the end screen image on the monitor 33 through the video controller 32. As a result, the end screen image is displayed on the monitor 33.

With the fault diagnosis system described above, in which a diagnostic item for diagnosing the contents of setting of software related to a functional block is displayed on a monitor, an instruction for selecting the diagnostic item thus displayed is entered, the diagnostic program is read from the diagnostic item table 36b based on the diagnostic item selected according to the instruction, and the diagnostic program is executed, it is possible to notify a fault of a diagnostic item earlier the higher its order of priority set by a user is.

Moreover, in the present embodiment, the class number is changed, and then the diagnostic program is read and executed based on the diagnostic item selected among a plurality of diagnostic items displayed on the monitor. However, the present invention is not limited thereto. Alternatively, an operator on the support center side may operate the PC 21 and instruct change of a diagnostic item to be displayed on the monitor and a class number corresponding to the diagnostic item by remotely controlling the PC 17 on the user side via the communication line 20. Thus, a fault of a diagnostic item can be detected earlier the higher its order of priority selected by the support center side is.

In addition, in the present embodiment, a diagnostic program is executed, which is read while changing the class number based on a diagnostic item selected from a plurality of diagnostic items displayed on the monitor. However, the present invention is not limited thereto. For example, the information related to execution time is stored as an execution history in a storage area in the HDD 36 along with a diagnostic code as a result of execution of a diagnostic program (i,j) and a class number (i,j) that corresponds to the diagnostic code. It may be alternatively possible to perform statistical processing for the past execution history stored in the diagnostic result table 36c and to change a plurality of diagnostic items having high rates of occurrence and class numbers corresponding thereto to be displayed on the monitor in order to increase more the order of priority of the class number of a diagnostic item the higher its rate of occurrence is. Thus, a fault of a diagnostic item can be detected earlier the higher its rate of occurrence is.

Furthermore, in the present embodiment, the class number on the screen is changed by way of an operation of the mouse on the PC 17 of the user side. However, the present invention is not limited thereto. For example, it may be alternatively possible to store the execution history in the database 22, which is periodically transferred from the diagnostic result table 36c of the PC 17 on the user side. The operator on the support center side operates the PC 21, performs statistical processing for the past execution history stored in the database 22 in order to increase more the order of priority of the class number of a diagnostic item the higher its rate of occurrence is. The operator remotely controls the PC 17 on the user side via the communication line 20 to change a plurality of diagnostic items and class numbers corresponding thereto to be displayed on the monitor. In this way, a fault of a diagnostic item can be detected earlier the higher its rate of occurrence is.

### Other Embodiments

Although, in the first to third embodiments, the fault diagnosis system is activated in a case where the user clicks a key on the display screen or a current time reaches the activation time, the present invention is not limited thereto. It may alternatively be configured such that the fault diagnosis system is activated after an operating system of a personal computer is initiated or in a case where the load of a CPU is relatively low continuously. In this case, it may be configured so as to execute diagnosis processing in the background without displaying the diagnostic code and to store the execution history to the HDD 36.

It may be possible to store the information related to execution time as an execution history in the HDD 36 along with a diagnostic code indicating a diagnostic result after execution of a diagnostic module and a class number that corresponds to the diagnostic code. In addition, it may be possible to cancel an instruction of execution at the time of initiation of an operating system of a terminal apparatus in a case where the result obtained by reading the information related to execution time indicates that it is within a predetermined period.

In Step S710 according to the third embodiment, the initial screen 91 including the printer diagnostic key 93, the audio diagnostic key 94, the digital camera diagnostic key 95, and the router diagnostic key 96 is displayed as the individual diagnostic items, for example. However, the present invention is not limited thereto. It may be alternatively possible to arbitrarily assign individual diagnostic items to the keys 93 to 96. In this case, a fault of a diagnostic item can be detected earlier the higher its order of priority set by a user is.

What is claimed is:

1. A terminal apparatus that diagnoses a status of operation of software with the execution of a plurality of diagnostic programs so as to diagnose contents established for the software related to a plurality of functional blocks of the terminal apparatus, comprising:
a first storage device for storing the plurality of diagnostic programs that are each provided in advance with a first class identification in first order of descending priority thereof;
a controller configured to:
update a first class identification in the first order of priority;
read out a diagnostic program associated with the first class identification from the first storage device at each time of updating; and
cause the diagnostic program to be executed; and
a display device for displaying a code indicating a result of a diagnosis as a result of the execution of the diagnostic program.

2. The terminal apparatus according to claim 1, further comprising:
a second storage device, and
an input device, wherein
the second storage device stores a second class identification that can be assigned priority in second order different from the first order, in addition to the first class identification,
the controller further configured to:
read out a second class identification from the second storage device and cause the display device to display the second class identification along with a diagnostic item performed by a diagnostic program;
allow a user to instruct through the input device a change of the second class identification displayed by the display device;
update the second class identification stored in the second storage device in accordance with the instruction provided by the user through the input device; and
read out a diagnostic program corresponding to the second class identification from the first storage device in accordance with the second class identification read out from the second storage device and cause the diagnostic program to be executed.

3. The terminal apparatus according to claim 1,
wherein the display device displays a diagnostic code in a case where a diagnostic result has been obtained that indicates the environmental information including a condition established for the software, whether the contents established for the software are valid, and a type of an operating system, and the environmental condition including a result of operation.

4. The terminal apparatus according to claim 1, further comprising:
a transmitter for transmitting a diagnostic code indicating a diagnostic result as a result of the execution of the diagnostic program to a central apparatus; and
a receiver for receiving text data related to a solution corresponding to the diagnostic code from the central apparatus.

5. The terminal apparatus according to claim 4,
wherein the transmitter transmits a diagnostic code in a case where a diagnostic result has been obtained that indicates the environmental information including a condition established for the software, whether the contents established for the software are valid, and a type of an operating system, and the environmental condition including a result of operation.

6. The terminal apparatus according to claim 1,
wherein the diagnostic code comprises a 2-byte code.

7. The terminal apparatus according to claim 1, wherein the controller is further configured to:
cause the display device to display diagnostic items to be used for diagnosing the contents established for the software;
allow the user to enter an instruction for selecting a diagnostic item through the input device;
read out a diagnostic program from the first storage device in accordance with the diagnostic item entered by the user; and
cause the diagnostic program to be executed.

8. The terminal apparatus according to claim 1, further comprising:
a third storage device for storing historical data related to time at which a diagnostic program is executed, along with a diagnostic code and a first class identification corresponding thereto,
wherein when the time read from the third storage device lies within a predetermined period of time, the controller is configured to inhibit the execution of the diagnostic program at a start of the terminal apparatus.

9. The terminal apparatus according to claim 1, further comprising:
a third storage device for storing historical data related to time at which a diagnostic program is executed, along with a diagnostic code and a first class identification corresponding thereto,
wherein after a start of an operating system of the terminal apparatus or when a load imposed on the controller is continuously low, the controller is further configured to:
execute one of a part and the entirety of the diagnostic programs; and
cause the historical data to be stored in the third storage device while causing the diagnostic code not to be displayed on the display device.

10. A method for diagnosing a status of operation of software with a plurality of diagnostic programs that diagnoses contents established for the software related to a plurality of functional blocks of the terminal apparatus, the method comprising:
causing a storage device to store the plurality of diagnostic programs that are each provided in advance with a class identification in order of descending priority thereof;
updating a class identification in the order of priority;
reading out a diagnostic program associated with the class identification from the storage device at each time of updating;
causing the diagnostic program to be executed; and
displaying a code indicating a result of a diagnosis as a result of the execution of the diagnostic program.

11. A storage medium encoded with a machine-readable computer program code for diagnosing a status of operation of software so as to diagnose contents established for the software related to a plurality of functional blocks, the storage medium including instructions for causing a controller to implement a method comprising:
causing a storage device to store the plurality of diagnostic programs that are each provided in advance with a class identification in order of descending priority thereof;
updating a class identification in the order of priority;
reading out a diagnostic program associated with the class identification from the storage device at each time of updating;
causing the diagnostic program to be executed; and
displaying a code indicating a result of a diagnosis as a result of the execution of the diagnostic program.
